(19) United States
(12) Patent Application Publication
(10) Pub. No.: US 2013/0244674 A1
(43) Pub. Date: Sep. 19, 2013

(54) MOBILE TERMINAL, RADIO BASE STATION, CONTROL METHOD FOR A MOBILE TERMINAL AND METHOD FOR A RADIO BASE STATION

(71) Applicant: Takahiro TSUTSUI, Tokyo (JP)

(72) Inventor: Takahiro TSUTSUI, Tokyo (JP)

(21) Appl. No.: 13/845,355

(22) Filed: Mar. 18, 2013

(30) Foreign Application Priority Data
Mar. 19, 2012 (JP) 2012-062174

(51) Int. Cl. H04W 72/04

(52) U.S. Cl. CPC H04W 72/04
USPC 455/450

(57) ABSTRACT

A mobile terminal in accordance with one of the 3GPP (Third Generation Partnership Project) standards is provided including a receiver that receives an incoming message comprising a predetermined information element from a base station. The mobile terminal also includes a memory that stores a value of the predetermined information element as a received element value. The mobile station also includes a controller that stores the received element value in place of a previously stored element value corresponding to a previously received information element. The mobile station also includes a transmitter that transmits, to the base station, an outgoing message comprising identification information identifying the incoming message received by the receiver.

### CROSS-REFERENCE TO RELATED APPLICATION

This application is based upon and claims the benefit of priority from Japanese patent application No. 2012-062174, filed on Mar. 19, 2012, the disclosure of which is incorporated herein in its entirety by reference.

### BACKGROUND

The exemplary embodiments relate to a mobile communication system, a communication apparatus, and a communication method.

A mobile communication system in LTE (Long Term Evolution) defined by 3GPP (Third Generation Partnership Project) includes a mobile station (UE: User Equipment), a base station (eNB: evolved Node B), an MME (Mobility Management Entity), and an S-GW (Serving Gateway).

As shown in FIG. 1, a UE wirelessly communicates with an eNB, and the interface therebetween is defined as Uu. The eNB communicates with an MME and an S-GW that are nodes in a core network, and the interface therebetween is defined as S1-AP (S1 Application Protocol). Communication may also be conducted between eNBs, and the interface therebetween is defined as X2-AP (X2 Application Protocol).

As shown in Non-patent literature 1 (Evolved Universal Terrestrial Radio Access (E-UTRA) and Evolved Universal Terrestrial Radio Access Network (E-UTRAN); Overall description; Stage 2 [3GPP TS36.300 V9.9.0]), an RRC (Radio Resource Control) protocol is used as an L3 (Layer 3) protocol for a control plane between the UE and the eNB. Further, as shown in Non-patent literature 2 (Evolved Universal Terrestrial Radio Access (E-UTRA); Radio Resource Control (RRC); Protocol specification [3GPP TS36.331 V9.9.0]), a message of RRC includes a plurality of IEs (information elements). The specification of RRC includes the definition of Need ON in which a predetermined IE may be optionally included in the message, and if the message is received by the UE and in case where the IE is not included in the received message, the UE takes no action for this IE and uses the currently held set value for the IE. Accordingly, when the IE specified as Need ON is not included in an RRC message transmitted from the eNB, the UE keeps holding the currently held set value for the IE. Meanwhile, when the IE is included in the message, the UE updates the set value for the IE with the value set in the message. In this way, for the IE specified as NeedON, the eNB is able to notify the UE of only the difference information (delta configuration).

Accordingly, when transmitting the RRC message to the UE, if the set value that is currently held by the UE can be continuously used for the IE specified as Need ON, the eNB may not include the IE in the message. Accordingly, it is possible to reduce the size of the RRC message to be transmitted, whereby it is expected to improve utilization efficiency of radio resources.

The aforementioned background art has a problem that it is impossible to effectively use the function of delta configuration in a sequence in which the RRC message cannot be successfully transmitted or received between the UE and the eNB. Hereinafter, with reference to the drawings, description will be made with specific examples.

FIG. 2 is a diagram showing a normal sequence regarding an RRC Connection Reconfiguration message according to a related art. First, in a state in which each of a UE 100, an eNB 200, and an MME 300 is active (S1000), the eNB 200 transmits RRC Connection Reconfiguration to the UE 100 by using as a trigger one of three cases shown in S1100 (S1200). The first case is a case in which the eNB 200 receives an RRC message from the UE 100 (S1110), and upon receiving this message, the eNB 200 generates an RRC message (S1111). The second case is a case in which the eNB 200 receives an S1-AP message from the MME 300 (S1120), and upon receiving this message, the eNB 200 generates an RRC message (S1121). The third case is a case in which the eNB 200 generates an RRC message by its internal trigger (S1130). After that, the UE 100 receives the RRC Connection Reconfiguration (S1200), and transmits an RRC Connection Reconfiguration Complete message to the eNB 200 (S1201). The detail of each message described above is disclosed in Non-patent literature 2.

FIG. 3 is a diagram showing a sequence when the sequence shown in FIG. 2 cannot be successfully executed in the related art. First, each of the UE 100, the eNB 200, and the MME 300 executes the sequence at S1100 shown in FIG. 2. After that, it is assumed that any of the two kinds of failures shown in S2100 and S2200 occurs for some reason such as degradation of quality of the radio transmission path. The first case (S2100) is the case in which, while the eNB 200 transmitted RRC Connection Reconfiguration, this message does not reach the UE 100 (S2101). In the second case (S2200), the UE 100 receives the RRC Connection Reconfiguration transmitted from the eNB 200 (S2201), and updates the set value for the IE with the set value in the message (S2202). Subsequently, while the UE 100 transmitted RRC Connection Reconfiguration Complete to the eNB 200, the eNB 200 cannot successfully receive this message (S2203). After S2100 or S2200, the UE 100 transmits an RRC Connection Reestablishment Request message to the eNB 200 to request re-connection (S2300). Upon receiving this message, the eNB 200 transmits RRC Connection Reestablishment to the UE 100 (S2301). Subsequently, upon receiving this message, the UE 100 transmits RRC Connection Reestablishment Complete to the eNB 200 (S2302). Next, the eNB 200 transmits an RRC Connection Reconfiguration message to the UE 100 (S2303). Subsequently, the UE 100 transmits RRC Connection Reconfiguration Complete to the eNB 200 (S2304). The detail of each message stated above is disclosed in Non-patent literature 2.

The eNB 200 cannot determine whether the UE 100 has not updated the set value for the IE by the RRC Connection Reconfiguration as in the first case (S2100) or the UE 100 has updated the set value for the IE as in the second case (S2200). Accordingly, even when there is an IE specified as Need ON in the message transmitted to the UE 100 in S2301 and S2303, the eNB 200 needs to include all IEs in the message to set the value, which inhibits reduction in size of messages.

### SUMMARY

An exemplary object of the exemplary embodiments is to provide a mobile communication system, a communication apparatus, and a communication method that are able to solve the aforementioned problems. However, the exemplary embodiments may achieve objectives other than those described above. Further, exemplary embodiments are not required to achieve the objectives described above, and an exemplary embodiment may not achieve any of the objectives described above.

A mobile communication system according to the exemplary embodiment is a mobile communication system including a first communication apparatus and a second communication apparatus that communicates with the first communication apparatus. In this communication system, the first communication apparatus includes: a first processor that performs processing regarding a protocol, the protocol defining that a predetermined information element is optionally included in a message, and if a communication apparatus receives the message and in case the information element is not included in the received message, the communication apparatus that received the message takes no action regarding the information element and uses a set value for the information element that is currently held; a first receiver that receives a message defined by the protocol from the second communication apparatus; and a first transmitter that transmits a first message defined by the protocol to the second communication apparatus, the first message including identification information of a message that the first receiver last successfully received. The second communication apparatus includes: a second processor that performs processing regarding the protocol; a second receiver that receives the first message from the first communication apparatus; and a determination unit that determines whether to include a predetermined information element in a second message that is defined by the protocol and is to be transmitted to the first communication apparatus based on the identification information.

A first communication apparatus according to the exemplary embodiment is a first communication apparatus that communicates with a second communication apparatus. This first communication apparatus includes: a first processor that performs processing regarding a protocol, the protocol defining that a predetermined information element is optionally included in a message, and if a communication apparatus receives the message and in case the information element is not included in the received message, the communication apparatus that received the message takes no action regarding the information element and uses a set value for the information element that is currently held; a first receiver that receives a message defined by the protocol from the second communication apparatus; and a first transmitter that transmits a first message defined by the protocol to the second communication apparatus, the first message including identification information of a message that the first receiver last successfully received.

A second communication apparatus according to the exemplary embodiment is a second communication apparatus that communicates with a first communication apparatus. This second communication apparatus includes: a second processor that performs processing regarding a protocol, the protocol defining that a predetermined information element is optionally included in a message, and if a communication apparatus receives the message and in case the information element is not included in the received message, the communication apparatus that received the message takes no action regarding the information element and uses a set value for the information element that is currently held; a second receiver that receives a first message defined by the protocol from the first communication apparatus, the first message including identification information of a message that is defined by the protocol and that the first communication apparatus last successfully received from the second communication apparatus; and a determination unit that determines whether to include the predetermined information element in a second message that is defined by the protocol and is to be transmitted to the first communication apparatus based on the identification information.

A communication method according to the exemplary embodiment is a communication method in a mobile communication system including a first communication apparatus and a second communication apparatus that communicates with the first communication apparatus. This method includes the steps of: performing processing regarding a protocol by the first communication apparatus, the protocol defining that a predetermined information element is optionally included in a message, and if a communication apparatus receives the message and in case the information element is not included in the received message, the communication apparatus that received the message takes no action regarding the information element and uses a set value for the information element that is currently held; receiving, by the first communication apparatus, a message defined by the protocol from the second communication apparatus; transmitting, by the first communication apparatus, a first message defined by the protocol to the second communication apparatus, the first message including identification information of a message that the first communication apparatus last successfully received; performing processing regarding the protocol by the second communication apparatus; receiving, by the second communication apparatus, the first message from the first communication apparatus; and determining based on the identification information by the second communication apparatus whether to include the predetermined information element in a second message that is defined by the protocol and is to be transmitted to the first communication apparatus.

A communication method according to the exemplary embodiment is a communication method in a first communication apparatus that communicates with a second communication apparatus. This method includes the steps of: performing processing regarding a protocol, the protocol defining that a predetermined information element is optionally included in a message, and if a communication apparatus receives the message and in case the information element is not included in the received message, the communication apparatus that received the message takes no action regarding the information element and uses a set value for the information element that is currently held; receiving a message defined by the protocol from the second communication apparatus; and transmitting a first message defined by the protocol to the second communication apparatus, the first message including identification information of a message that the first communication apparatus last successfully received.

A communication method according to the exemplary embodiment is a communication method in a second communication apparatus that communicates with a first communication apparatus. This method includes the steps of: performing processing regarding a protocol, the protocol defining that a predetermined information element is optionally included in a message, and if a communication apparatus receives the message and in case the information element is not included in the received message, the communication apparatus that received the message takes no action regarding the information element and uses a set value for the information element that is currently held; receiving a first message defined by the protocol from the first communication apparatus, the first message including identification information of a message that is defined by the protocol and that the first communication apparatus last successfully received from the second communication apparatus; and determining whether to include the predetermined information element in a second message that is defined by the protocol and is to be transmitted to the first communication apparatus based on the identification information.

According to the exemplary embodiment, a second communication apparatus is able to determine whether to include a predetermined information element in a message to be transmitted to a first communication apparatus based on identification information of a message that is last successfully received by the first communication apparatus.

### BRIEF DESCRIPTION OF THE DRAWINGS

The above and other aspects, features, and advantages of the exemplary embodiment will become more apparent from the following description of certain exemplary embodiments when taken in conjunction with the accompanying drawings, in which:

FIG. 1 is a diagram showing a configuration of a mobile communication system of LTE defined by the 3GPP;

FIG. 2 is a sequence diagram of communication using an RRC protocol according to a related art;

FIG. 3 is a sequence diagram of communication using the RRC protocol according to the related art;

FIG. 4 is a diagram showing a configuration according to a first exemplary embodiment;

FIG. 5 is a sequence diagram showing an operation according to the first exemplary embodiment;

FIG. 6 is a diagram showing a configuration of a UE according to a second exemplary embodiment;

FIG. 7 is a diagram showing a configuration of an eNB according to the second exemplary embodiment;

FIG. 8 is a diagram showing a configuration of an MME according to the second exemplary embodiment;

FIG. 9 is a sequence diagram showing an operation according to the second exemplary embodiment;

FIG. 10 is a diagram showing an example of messages to be transmitted from the UE to the eNB in the second exemplary embodiment;

FIG. 11 is a diagram showing an example of messages to be transmitted from the UE to the eNB in the second exemplary embodiment;

FIG. 12 is a sequence diagram showing an operation according to a third exemplary embodiment;

FIG. 13 is a sequence diagram showing an operation according to the third exemplary embodiment; and

FIG. 14 is a sequence diagram showing an operation according to the third exemplary embodiment.

### EXEMPLARY EMBODIMENTS

Hereinafter, with reference to the drawings, exemplary embodiments will be described. The word “exemplary” is used herein to mean “serving as an example, instance, or illustration”. Any embodiment described herein as “exemplary” is not necessarily to be construed as preferred or advantageous over other embodiments.

### First Exemplary Embodiment

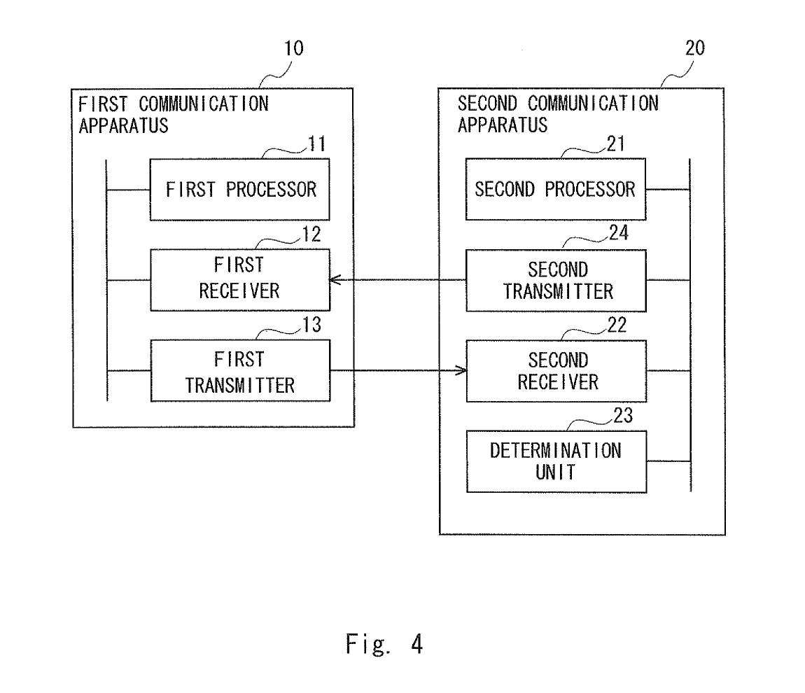

FIG. 4 is a diagram showing one example of a configuration according to a first exemplary embodiment. A mobile communication system according to this exemplary embodiment includes a first communication apparatus 10 and a second communication apparatus 20 that is capable of communicating with the first communication apparatus.

The first communication apparatus 10 includes a first processor 11, a first receiver 12, and a first transmitter 13. The first processor 11 performs processing regarding a predetermined protocol. This protocol defines that a predetermined information element is optionally included in a message, and if a communication apparatus receives the message and in case where the information element is not included in the received message, the communication apparatus takes no action regarding the information element and uses the currently held set value for the information element. The first receiver 12 receives a message defined by the protocol from the second communication apparatus. The first transmitter 13 transmits a first message defined by the protocol to the second communication apparatus, the first message including identification information of a message that the first receiver last successfully received.

The second communication apparatus 20 includes a second processor 21, a second receiver 22, a determination unit 23, and a second transmitter 24. The second processor 21 performs processing regarding the protocol. The second receiver 22 receives the above-mentioned first message from the first communication apparatus. The determination unit 23 determines whether to include a predetermined information element in a second message defined by the protocol based on the identification information included in the first message. The second transmitter 24 can transmit the second message based on the result determined by the determination unit 23.

Next, with reference to the drawings, the detail of operations of an UE 100, an eNB 200, and an MME 300 in the first exemplary embodiment will be described.

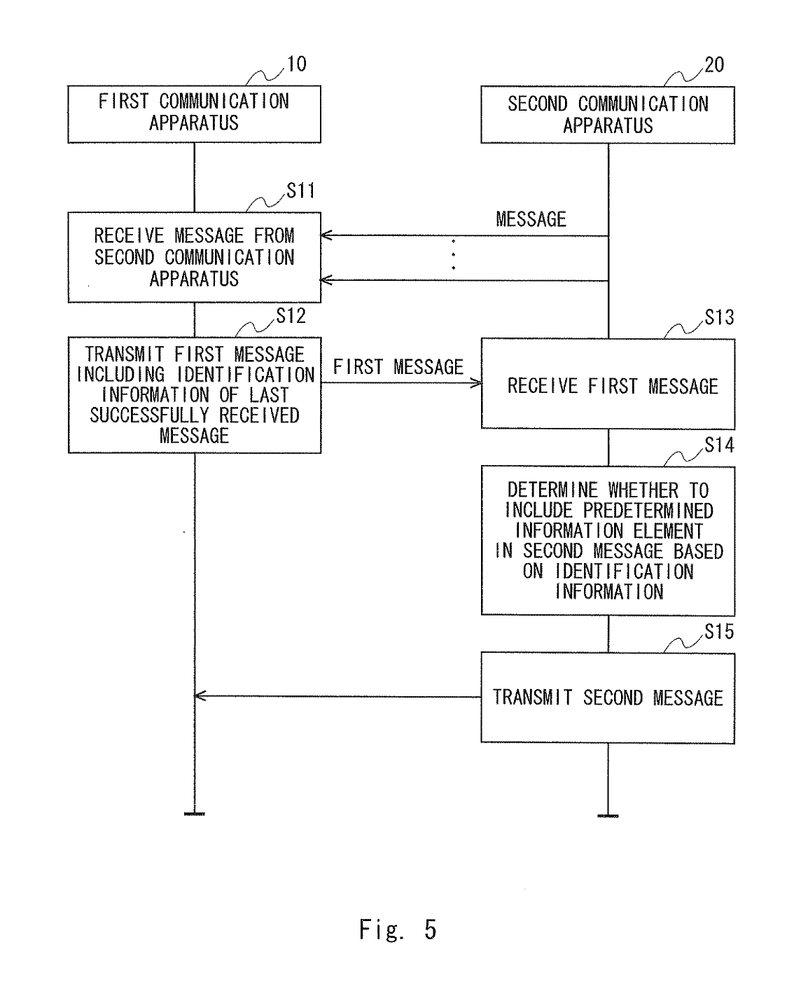

FIG. 5 is a sequence diagram showing one example of an operation according to the first exemplary embodiment.

In S11, the first communication apparatus 10 receives, by the first receiver 12, messages defined by the protocol from the second communication apparatus. Each of the messages includes identification information of the message.

In S12, the first communication apparatus 10 adds identification information included in the message that the first receiver 12 last successfully received to the first message, to transmit, by the first transmitter 13, the first message to the second communication apparatus 20.

In S13, the second communication apparatus 20 receives the first message by the second receiver 22.

In S14, the second communication apparatus 20 determines by the determination unit 23 whether to include a predetermined information element in the second message that is defined by the protocol and is to be transmitted to the first communication apparatus 10 based on the identification information included in the first message. More specifically, the determination unit 23 determines the set value for the predetermined information element in the first communication apparatus 10 based on the identification information, determines that the predetermined information element should not be included when the determined set value is the same to a set value for the predetermined information element which should be set in the second message, and determines that the predetermined information element should be included when the determined set value is different from the set value for the predetermined information element which should be set in the second message.

In S15, the second communication apparatus 20 does not transmit the second message by the transmitter 24 when the predetermined information element determined by the determination unit 23 to be included in the second message does not exist, and can transmit the second message to the first communication apparatus 10 when the predetermined information element exists.

As described above, the second communication apparatus 20 can determine the set value for the predetermined information element in the first communication apparatus 10 based on the identification information of the message which was last successfully received by the first communication apparatus 10. Then it is possible to determine whether to include the predetermined information element in the second message to be transmitted to the first communication apparatus 10 based on the determined result. Accordingly, it is possible to reduce the size of the second message under predetermined conditions, and thereby to improve utilization efficiency of transmission path resources.

### Second Exemplary Embodiment

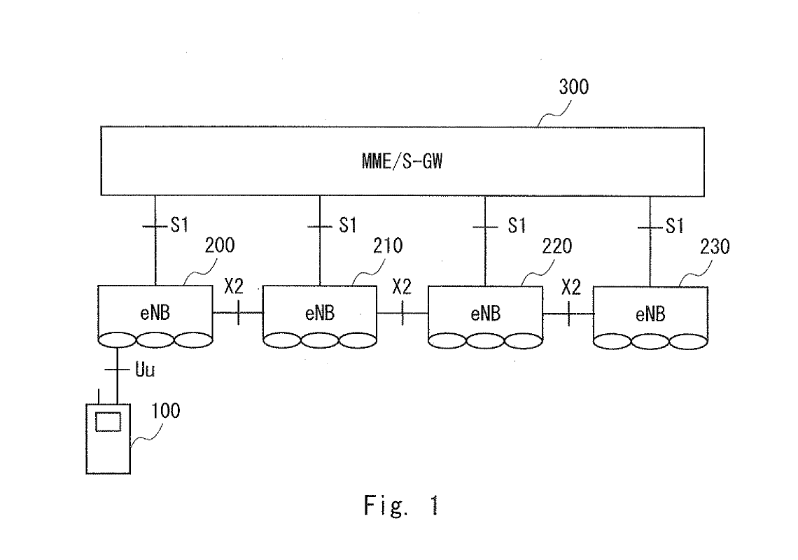

In a second exemplary embodiment, the first exemplary embodiment is applied to the mobile communication system in LTE defined by the 3GPP shown in FIG. 1. Hereinafter, with reference to the drawings, a configuration of each apparatus will be described.

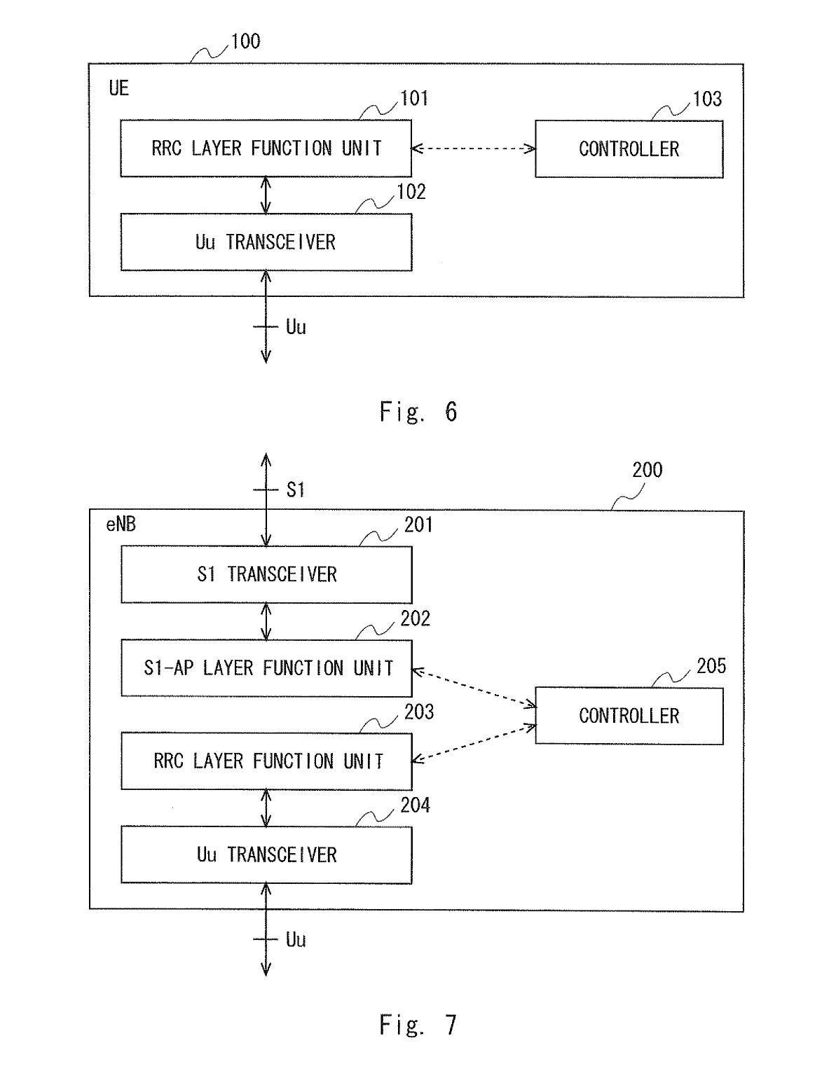

FIG. 6 is a diagram showing a configuration of the UE 100. The UE 100 performs processing regarding the RRC protocol by an RRC layer function unit 101 according to the control by a controller 103, and transmits/receives RRC messages to/from the eNB 200 through a Uu transceiver 102.

FIG. 7 is a diagram showing a configuration of the eNB 200. The eNB 200 performs processing regarding the RRC protocol by an RRC layer function unit 203 according to the control by a controller 205, and transmits/receives RRC messages to/from the UE 100 through a Uu transceiver 204. Further, the eNB 200 performs processing regarding the S1 protocol in an S1-AP layer function unit 202 according to the control by the controller 205, and transmits/receives S1-AP messages to/from the MME 300 through an S1 transceiver 201. While not being illustrated in the drawings, since the configurations of an eNB 210, an eNB 220, and an eNB 230 are similar to that of the eNB 200, description thereof will be omitted.

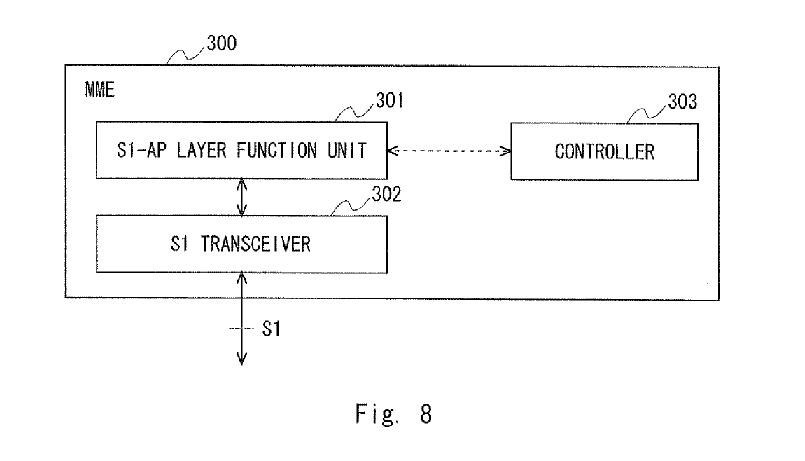

FIG. 8 is a diagram showing a configuration of the MME 300. The MME 300 performs processing regarding the S1 protocol by an S1-AP layer function unit 301 according to the control by a controller 303, and transmits/receives S1-AP messages to/from the eNB 200 through an S1 transceiver 302.

Next, with reference to the drawings, the detail of operations of the UE 100, the eNB 200, and the MME 300 according to the second exemplary embodiment will be described.

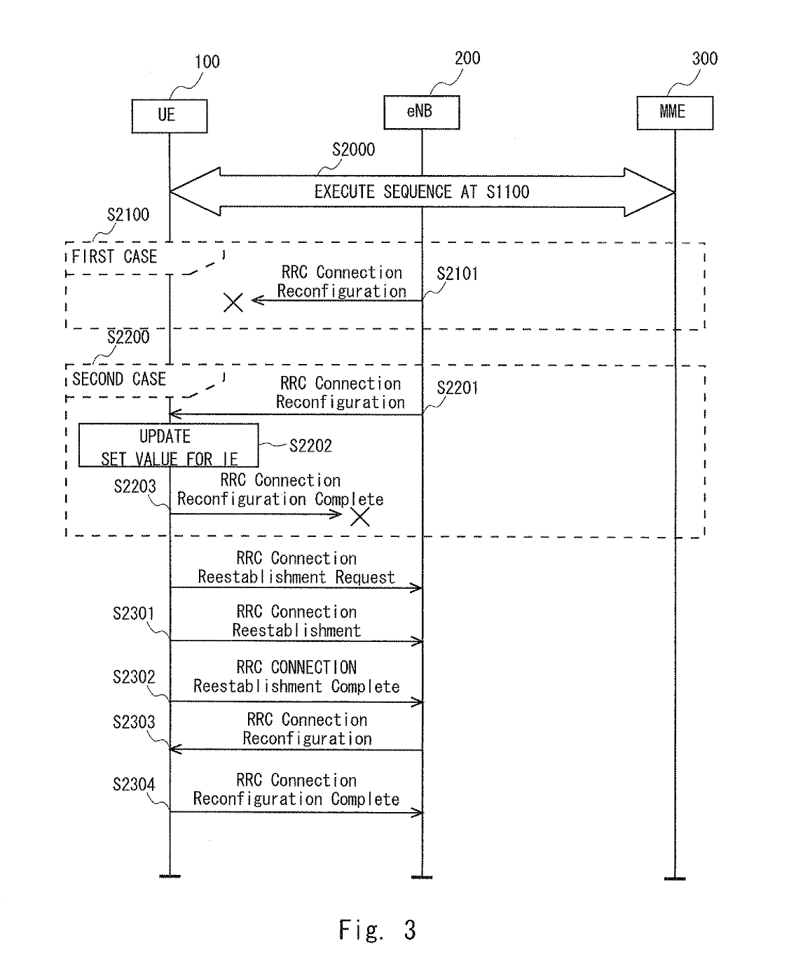

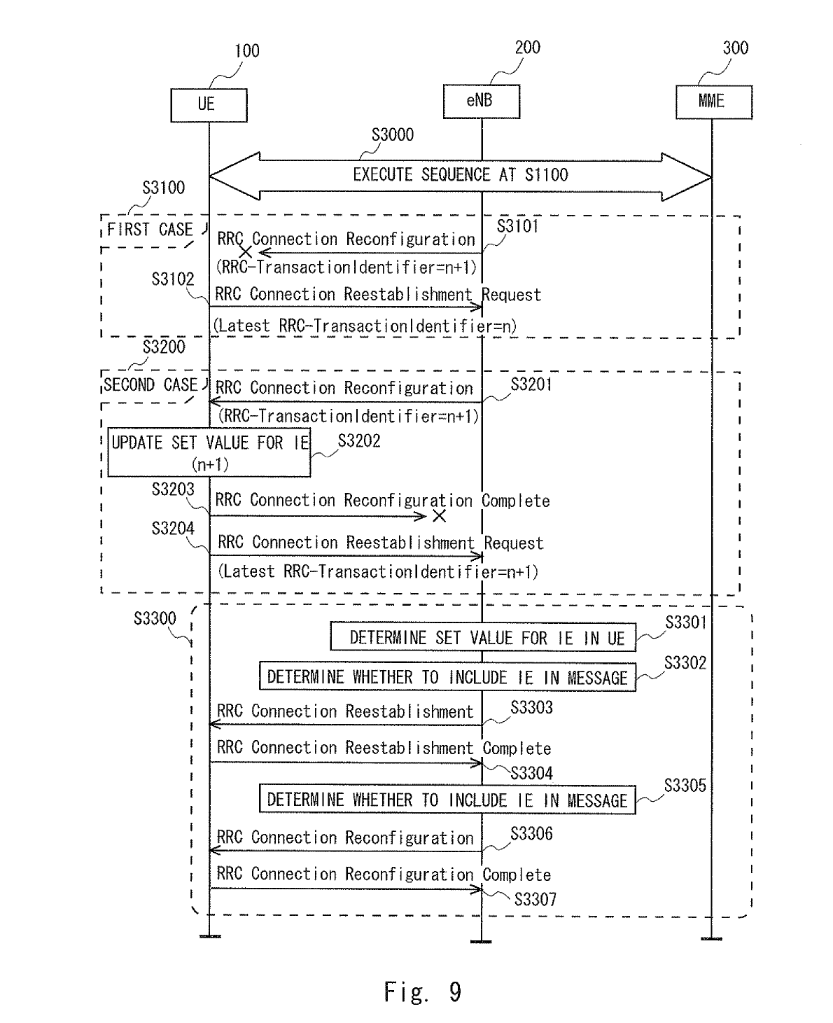

FIG. 9 is a sequence diagram showing an example of an operation according to the second exemplary embodiment. FIG. 9 shows an operation when the exemplary embodiment is applied to the sequence shown in FIG. 3.

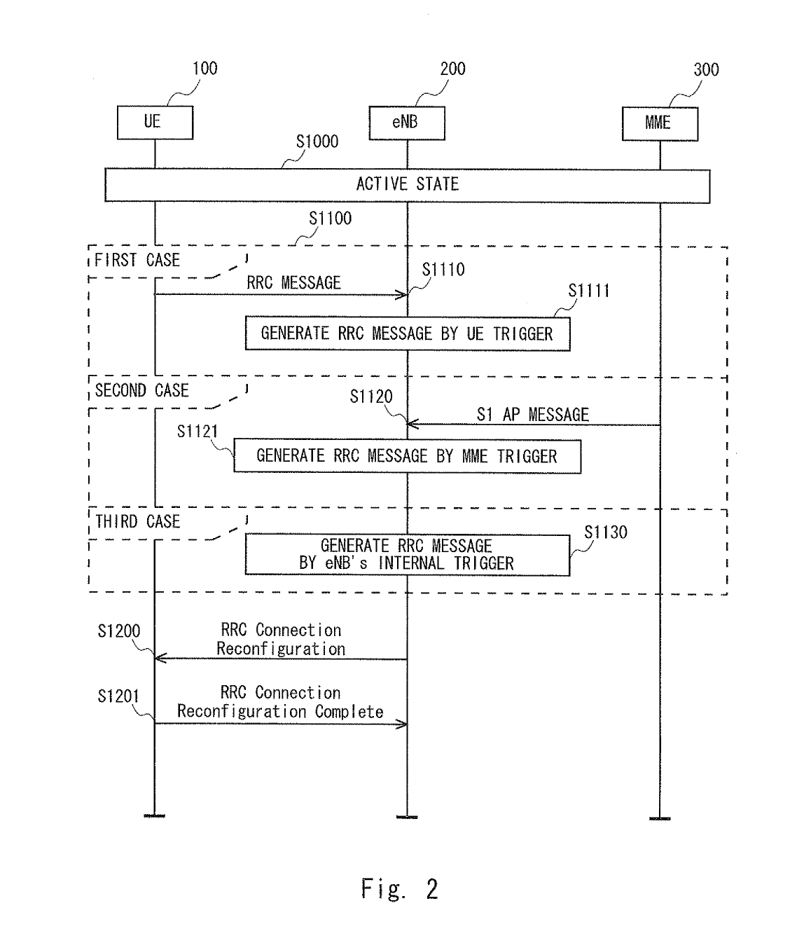

In S3000, each of the UE 100, the eNB 200, and the MME 300 executes the sequence at S1100 shown in FIG. 2.

The first case shown in S3100 will be described. The sequence at S3100 corresponds to S2100 shown in FIG. 3. The eNB 200 transmits to the UE 100 RRC Connection Reconfiguration in which RRC-TransactionIdentifier is set to “n+1”. However, for some reason such as degradation of quality of the radio transmission path, the UE 100 cannot successfully receive the message (S3101). Note that RRC-TransactionIdentifier is an IE for identification information to identify the transmitted RRC Connection Reconfiguration message. While not shown in FIG. 9, it is assumed that the value of the identification information has already become “n” according to the transmission and reception of messages between the eNB 200 and the UE 100 that are executed before start of the sequence. Accordingly, the value of the identification information at S3101 is counted up by one and becomes “n+1”. Subsequently, the UE 100 transmits RRC Connection Reestablishment Request to the eNB 200 to request re-connection, and the eNB 200 receives this message. This message includes Latest RRC-TransactionIdentifier, which is an IE to indicate identification information of the message that was last successfully received by the UE 100 from the eNB 200. In S3101, the eNB 200 sets “n+1” for RRC-TransactionIdentifier to be transmitted. Thus, if the UE 100 could successfully receive the message, the value of Latest RRC-TransactionIdentifier in S3102 is “n+1”. However, since the UE 100 cannot successfully receive the message at S3101, the UE 100 sets the existing value “n” for Latest RRC-TransactionIdentifier (S3102). Note that the Latest RRC-TransactionIdentifier is an IE that is not disclosed in Non-patent literature 2.

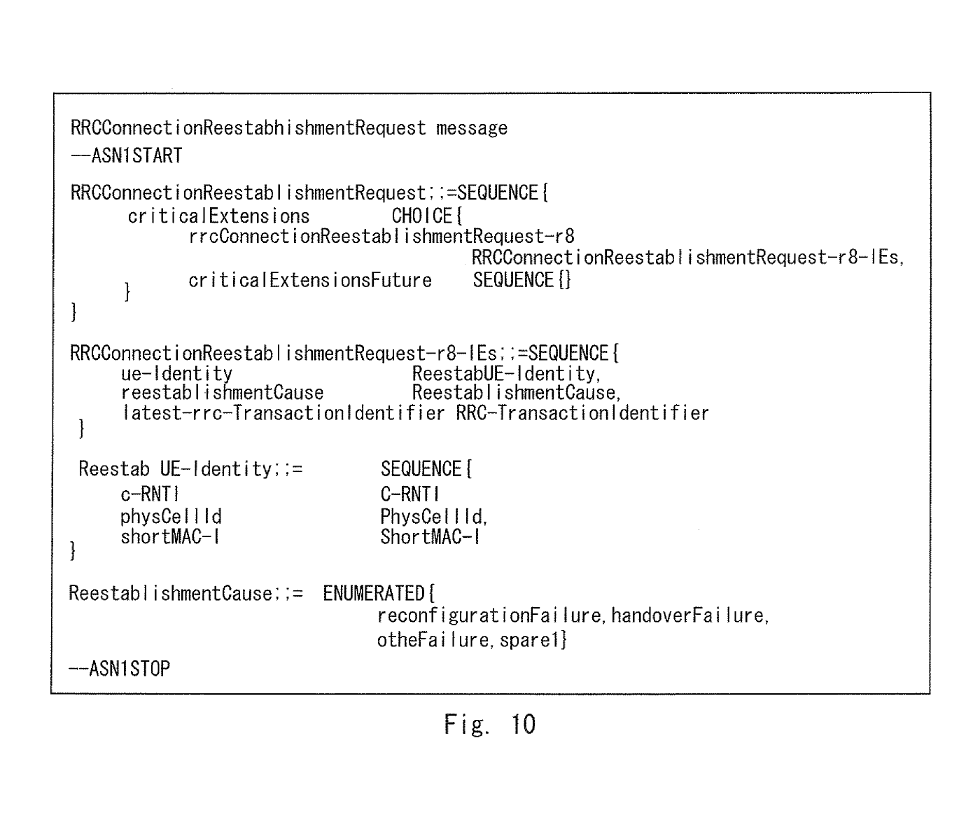

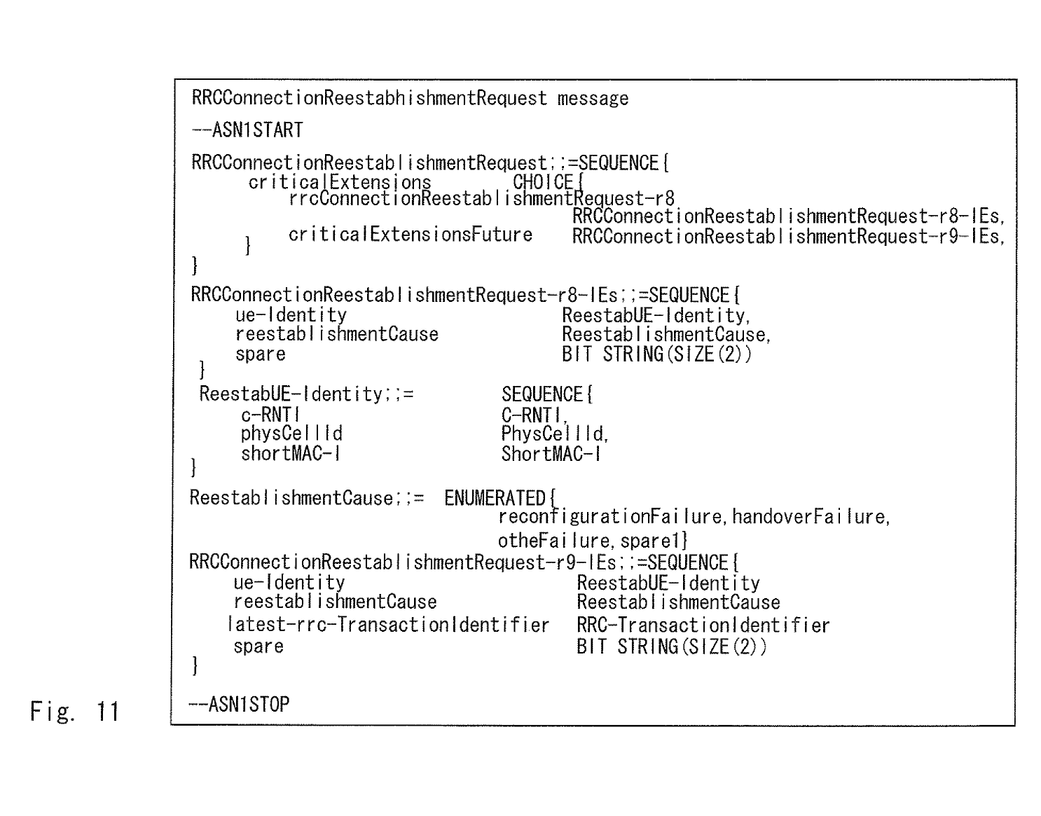

FIGS. 10 and 11 each show a configuration example of a message when the IE for Latest RRC-TransactionIdentifier is added to the RRC Connection Reestablishment Request message disclosed in Non-patent literature 2. The term latest-rrc-TransactionIdentifier in FIGS. 10 and 11 corresponds to the Latest RRC-TransactionIdentifier. FIGS. 10 and 11 also show that the set value that latest-rrc-TransactionIdentifier may have is RRC-TransactionIdentifier.

The second case shown in S3200 will now be described. The sequence at S3200 corresponds to S2200 in FIG. 3. The eNB 200 transmits messages to the UE 200 as is similar to S3101. As is different from S3101, the UE 100 successfully receives the message (S3201). The UE 100 then updates the set value for the IE with the value set in the message at S3201 (S3202). Subsequently, while the UE 100 transmits RRC Connection Reconfiguration Complete to the eNB 200, the eNB 200 cannot receive this message (S3203). Accordingly, the UE 100 transmits RRC Connection Reestablishment Request to request re-connection to the eNB 200, and the eNB 200 receives this message (S3204). In this case, the UE 100 sets the value of Latest RRC-TransactionIdentifier to “n+1”. This is because the UE 100 successfully received the message in which RRC-TransactionIdentifier is “n+1” at S3201 and also updated the set value for the IE at S3202.

The operations from S3301 to S3307 shown in S3300 will be described hereinafter in detail.

In S3301, the eNB 200 determines the set value for the IE in the UE 100. More specifically, in the first case (S3100), it is found at S3102 that the Latest RRC-TransactionIdentifier is “n”. Therefore, the eNB 200 determines that the set value for the IE in the message at S3101 is not reflected in the current set value for the IE in the UE 100, and the current set value is the value before the transmission of the message. On the other hand, in the second case (S3200), it is found at S3204 that the Latest RRC-TransactionIdentifier is “n+1”. Therefore, the eNB 200 determines that the current set value for the IE in the UE 100 is the value set in the message at S3201.

In S3302, the eNB 200 determines whether to include a predetermined IE in the message to be transmitted next. More specifically, the eNB 200 determines, for the IE which is specified as Need ON among the IEs of RRC Connection Reestablishment to be transmitted at the next S3303, whether the set value which should be set in the message is the same to the current set value in the UE 100 determined at S3301. When the result shows that the values are the same, there is no need to notify it by the message. Therefore, the eNB 200 determines that the IE should not be included in the transmission message. In contrast, when the set value which should be set in the message is different from the current set value in the UE 100, the eNB 200 determines that the IE should be included in the transmission message.

In S3303, the eNB 200 transmits to the UE 100 RRC Connection Reestablishment in which the determined result at S3302 is reflected, and the UE 100 receives this message.

In S3304, the UE 100 transmits to the eNB 200 RRC Connection Reestablishment Complete, and the eNB 200 receives this message.

In S3305, the eNB 200 determines whether to include a predetermined IE in the message to be transmitted next, as is similar to S3302. More specifically, for the IE which is specified as Need ON among the IEs of RRC Connection Reconfiguration to be transmitted at the next S3306, the eNB 200 determines whether the set value which should be set in the message is the same to the current set value in the UE 100 determined at S3301. When the result shows that the values are the same, there is no need to notify it by the message. Therefore, the eNB 200 determines that the IE should not be included in the transmission message. In contrast, when the set value which should be set in the message is different from the current set value in the UE 100, the eNB 200 determines that the IE should be included in the transmission message.

In S3306, the eNB 200 transmits to the UE 100 RRC Connection Reconfiguration in which the determined result at S3305 is reflected, and the UE 100 receives this message.

In S3307, the UE 100 transmits to the eNB 200 RRC Connection Reconfiguration Complete, and the eNB 200 receives this message.

As described above, the eNB 200 can determine whether to include the IE which is specified as Need ON in the message to be transmitted based on the result obtained by determining the current set value for the IE in the UE 100. Accordingly, the eNB 200 can reduce the size of the message to be transmitted to the UE 100, thereby being able to improve utilization efficiency of radio resources.

### Third Exemplary Embodiment

In a third exemplary embodiment, the exemplary embodiment is applied to a sequence in which the eNB 200 successively transmits RRC Connection Reconfiguration to the UE 100 twice, while the eNB 200 transmits the RRC Connection Reconfiguration to the UE 100 once in the second exemplary embodiment.

Since the configuration in the third exemplary embodiment is similar to that in the second exemplary embodiment, description thereof will be omitted.

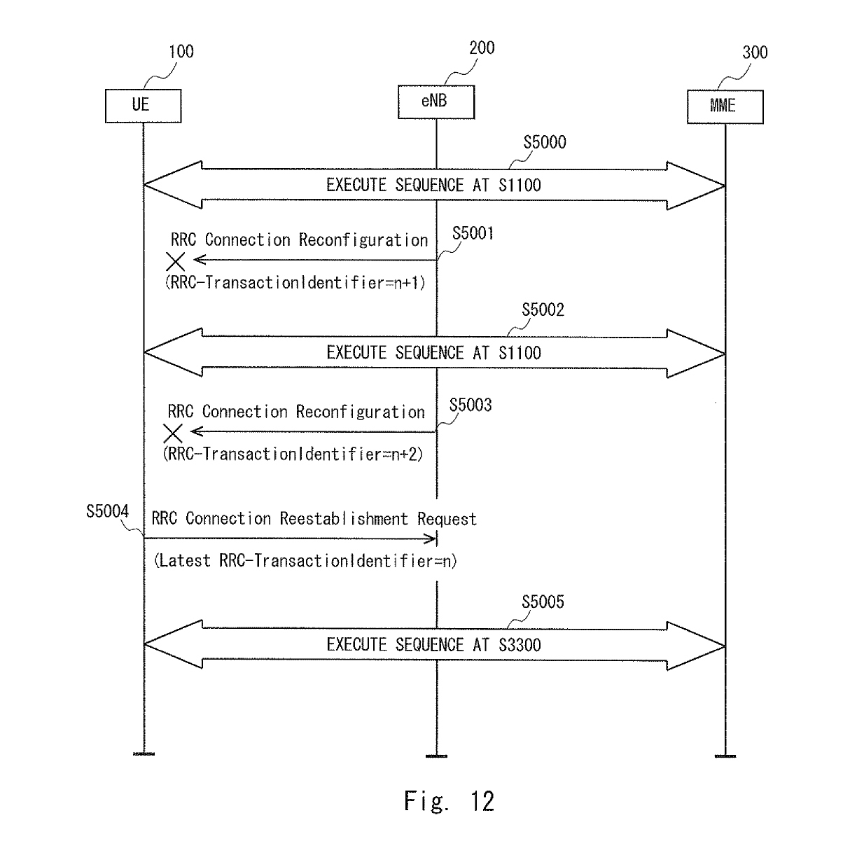

Hereinafter, with reference to FIGS. 12 to 14, an example of an operation according to the third exemplary embodiment will be described according to the patterns of failures that may occur.

FIG. 12 is a sequence diagram showing an example of an operation according to the third exemplary embodiment. First, upon execution of the sequence at S1100 shown in FIG. 2 by the UE 100, the eNB 200, and the MME 300 (S5000), the eNB 200 transmits to the UE 100 RRC Connection Reconfiguration in which the value of RRC-TransactionIdentifier is “n+1”. However, for some reason such as degradation of quality of the radio transmission path, the UE 100 cannot successfully receive this message (S5001). It is assumed here that the value of RRC-TransactionIdentifier proceeds to the value of “n” as a result of transmission and reception of messages between the eNB 200 and the UE 100 executed before this sequence starts, as is similar to the second exemplary embodiment. Subsequently, after the sequence at S1100 is further executed (S5002), the eNB 200 transmits to the UE 100 RRC Connection Reconfiguration in which the value of RRC-TransactionIdentifier is “n+2”. However, for some reason such as degradation of quality of the radio transmission path, the UE 100 cannot successfully receive the message (S5003). Therefore, the UE 100 transmits RRC Connection Reestablishment Request to the eNB 200 to start re-connection. Since the UE 100 has not successfully received any of the messages at S5001 and S5003, the value of Latest RRC-TransactionIdentifier is set to “n” (S5004).

Then, the eNB 200 and the UE 100 execute the similar sequence as S3300 in FIG. 9 (S5005). Since it is found at S5004 that the value of Latest RRC-TransactionIdentifier is “n”, the eNB 200 determines that the values set in the messages at S5001 and S5003 are not reflected in the current set value for the IE in the UE, and the current set value is the value before the transmission of these messages (S3301). The eNB 200 determines whether to include a predetermined IE in a message based on this determined result (S3302 and S3305), and transmits the message in which the determination is reflected to the UE 100 (S3303 and S3306). The other operations in S5005 are similar to those in S3300.

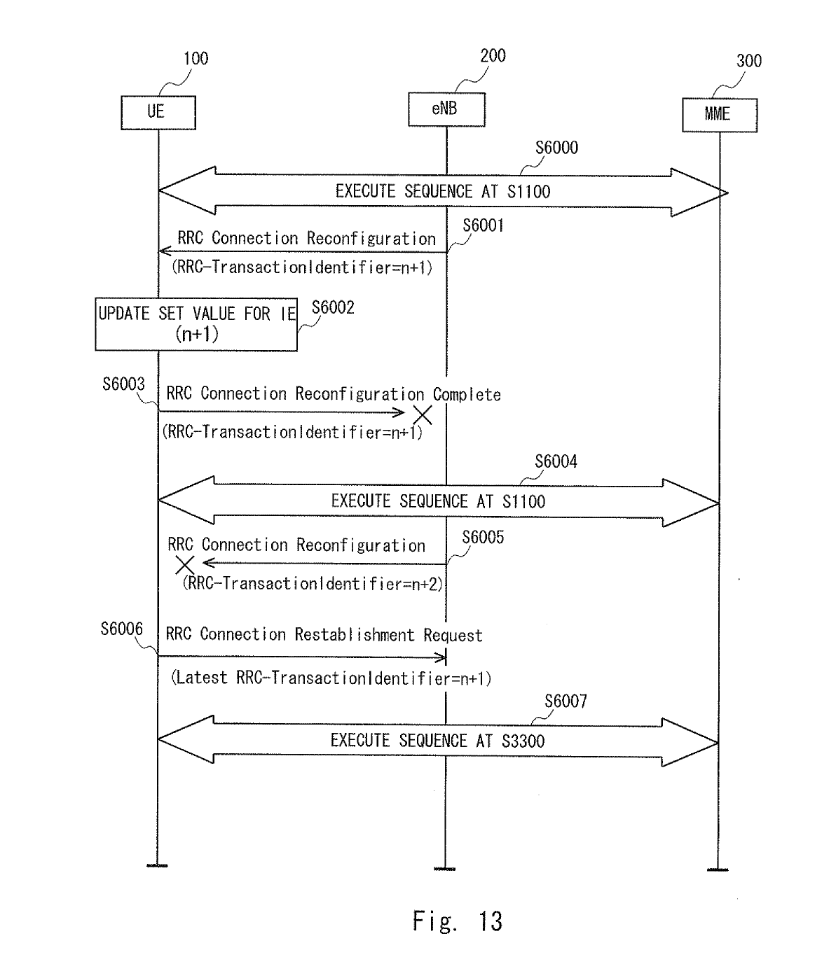

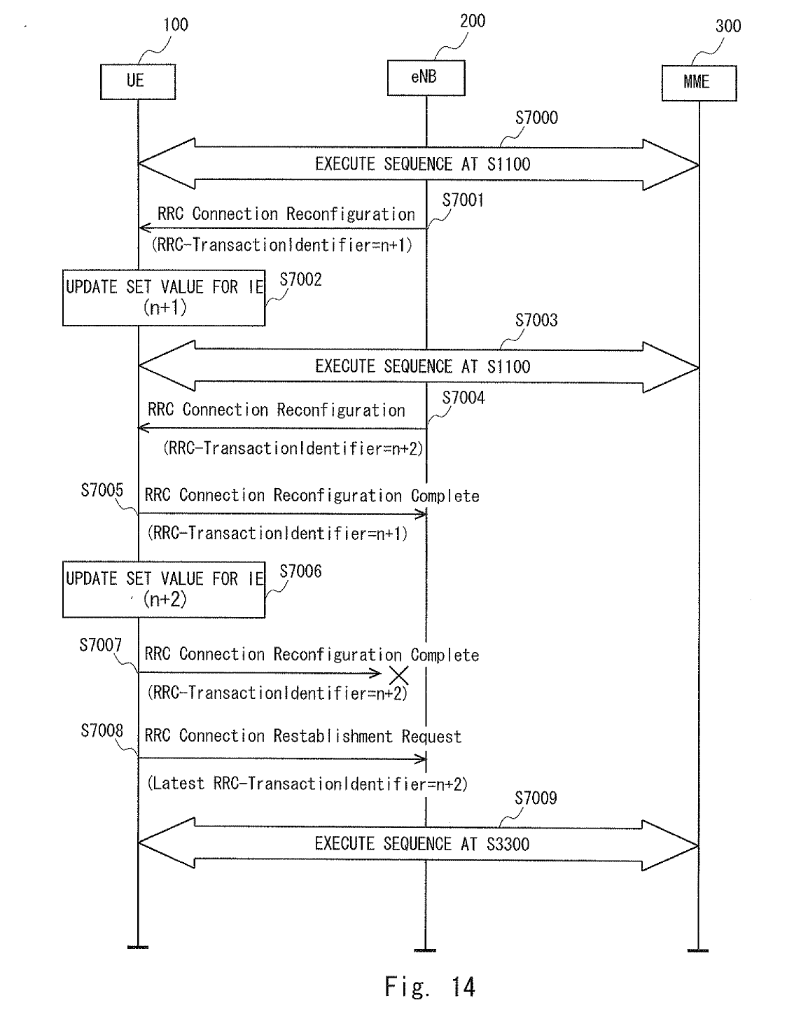

FIG. 13 is a sequence diagram showing an example of an operation according to the third exemplary embodiment upon occurrence of a failure which is different from that shown in FIG. 12. First, upon execution of the sequence at S1100 shown in FIG. 2 by the UE 100, the eNB 200, and the MME 300 (S6000), the eNB 200 transmits to the UE 100 RRC Connection Reconfiguration in which the value of RRC-TransactionIdentifier is “n+1”, and the UE 100 receives this message (S6001). Next, the UE 100 updates the set value for the IE with the value set in the message (S6002). Subsequently, the UE 100 transmits, as a response to S6001, RRC Connection Reconfiguration Complete in which the value of RRC-TransactionIdentifier is “n+1”. However, for some reason such as degradation of quality of the radio transmission path, the eNB 200 cannot successfully receive the message (S6003). Subsequently, after the sequence at S1100 is further executed (S6004), the eNB 200 transmits RRC Connection Reconfiguration to the UE 100. However, the UE 100 cannot successfully receive this message. Here, the value of RRC-TransactionIdentifier in the message is “n+2” since the value of n+1 is used at S6001 (S6005). After that, the UE 100 transmits RRC Connection Reestablishment Request to the eNB 200 to start re-connection, and the eNB 200 receives this message. The UE 100 sets the value of Latest RRC-TransactionIdentifier in the message to “n+1”. This is because, while the UE 100 could receive the message at S6001, the UE 100 has not successfully received the message at S6005 (S6006).

After that, the eNB 200 and the UE 100 execute the similar sequence as in S3300 in FIG. 9 (S6007). Since it is found at S6006 that the value of Latest RRC-TransactionIdentifier is “n+1”, the eNB 200 determines that the value set in the message at S6005 is not reflected in the current set value for the IE in the UE, and the current set value is the value set by the message at S6001 (S3301). The eNB 200 determines whether to include a predetermined IE in a message based on this determined result (S3302 and S3305), and transmits the message in which the determination is reflected to the UE 100 (S3303 and S3306). The other operations in S6007 are similar to those in S3300.

FIG. 14 is a sequence diagram showing an example of an operation according to the third exemplary embodiment upon occurrence of a failure which is different from failures shown in FIGS. 12 and 13. First, upon execution of the sequence at S1100 shown in FIG. 2 by the UE 100, the eNB 200, and the MME 300 (S7000), the eNB 200 transmits to the UE 100 RRC Connection Reconfiguration in which the value of RRC-TransactionIdentifier is “n+1”, and the UE 100 receives this message (S7001). The UE 100 then updates the set value for the IE with the value set in the message (S7002). Subsequently, after the sequence at S1100 is further executed (S7003), the eNB 200 transmits RRC Connection Reconfiguration to the UE 100, and the UE 100 receives this message. Since the value of “n+1” is used as the value of RRC-TransactionIdentifier in this message at S7001, the value of RRC-TransactionIdentifier in this message is “n+2” (S7004). Next, the UE 100 transmits to the eNB 200, as a response to S7001, RRC Connection Reconfiguration Complete in which the value of RRC-TransactionIdentifier is “n+1”, and the eNB 200 successfully receives this message (S7005). Further, since the UE 100 could successfully receive the message at S7004, the UE 100 updates the set value for the IE with the value set in the message (S7006). After that, the UE 100 transmits to the eNB 200, as a response to S7004, RRC Connection Reconfiguration Complete in which the value of RRC-TransactionIdentifier is “n+2”. However, the eNB 200 cannot successfully receive the message for some reason such as degradation of quality of the radio transmission path (S7007). Then, the UE 100 transmits RRC Connection Reestablishment Request in order to start re-connection. Since the UE 100 has successfully received the message at S7004 and completed the processing at S7006, the UE 100 sets the value of Latest RRC-TransactionIdentifier to “n+2” (S7008).

After that, the eNB 200 and the UE 100 each execute the sequence similar to that in S3300 shown in FIG. 9 (S7009). Since it is found here at S7008 that the value of Latest RRC-TransactionIdentifier is “n+2”, the eNB 200 determines that the current set value for the IE in the UE is the value set in the message at S7004 (S3301). The eNB 200 determines whether to include a predetermined IE in a message based on the determined result (S3302 and S3305), to transmit to the UE 100 the message in which the determination is reflected (S3303 and S3306). The other operations in S7009 are similar to those in S3300.

Described above is the exemplary embodiment when the exemplary embodiment is applied to the sequence in which the eNB 200 successively transmits RRC Connection Reconfiguration twice. However, the exemplary embodiment may be applied to a sequence in which the eNB 200 successively transmits RRC Connection Reconfiguration three or more times.

As described above, also in the sequence in which the eNB 200 successively transmits a plurality of messages to the eNB 100, the eNB 200 can determine whether to include the IE specified as Need ON in each message to be transmitted based on the result obtained by determining the current set value for the IE in the UE 100. Accordingly, the eNB 200 can reduce the size of the message to be transmitted to the UE 100 and therefore it is possible to improve utilization efficiency of radio resources.

While the present invention has been described in detail based on the preferred exemplary embodiments, it is needless to say that the present invention is not limited to the aforementioned description but may be changed in various ways without departing from the spirit of the present invention.

For example, in the second and third exemplary embodiments, the Latest RRC-TransactionIdentifier, which is the identification information of the message that the UE last successfully received, is included in the RRC Connection Reestablishment Request. However, it may also be applied to another RRC message that the UE transmits to the eNB.

Further, for RRC Connection Reestablishment and RRC Connection Reconfiguration, it is determined whether to include the IE specified as Need ON in these messages based on the Latest RRC-TransactionIdentifer in the second and third exemplary embodiments. However, it may also be applied to another RRC message that the eNB transmits to the UE.

Furthermore, while description has been omitted in the second and third exemplary embodiments, when the RRC message is transmitted by the UE trigger at S1100 shown in FIG. 2 or when the RRC message is transmitted by the MME trigger, the eNB may operate to send an appropriate response message according to the value of Latest RRC-TransactionIdentifer immediately after receiving the RRC Connection Reestablishment Request. Accordingly, the eNB can reduce time from reception of the message to the transmission of the response message.

It should be noted that the present inventive concept is not limited to the above exemplary embodiments but modification can be made as needed without deviating from the spirit and scope as defined by the claims.

What is claimed is:

1. A mobile terminal in accordance with one of the 3GPP (Third Generation Partnership Project) standards, the mobile terminal comprising:
a receiver that receives an incoming message comprising a predetermined information element from a base station;
a memory that stores a value of the predetermined information element as a received element value;
a controller that stores the received element value in place of a previously stored element value corresponding to a previously received information element; and
a transmitter that transmits, to the base station, an outgoing message comprising identification information identifying the incoming message received by the receiver.

2. The mobile terminal according to claim 1, wherein the identification information is related to an RRC Transaction Identifier.

3. The mobile terminal according to claim 1, wherein the outgoing message comprises an RRC (Radio Resource Control) message.

4. The mobile terminal according to claim 1, the predetermined information element is set as Need ON defined in accordance with one of the 3GPP.

5. A radio base station in accordance with one of the 3GPP (Third Generation Partnership Project), the radio base station comprising:
a transmitter that transmits an outgoing message comprising a predetermined information element to a mobile terminal;
a receiver that receives, from the mobile terminal, an incoming message comprising an identification information identifying the outgoing message received by the mobile terminal;
a memory that stores the identification information; and
a controller that performs a control of the predetermined information element based on the identification information.

6. The radio base station according to claim 5, wherein the control comprises a determination whether the predetermined information element is included into the outgoing message.

7. The radio base station according to claim 5, wherein the identification information is related to an RRC Transaction Identifier.

8. The radio base station according to claim 5, wherein the incoming message is an RRC (Radio Resource Control) message.

9. The radio base station according to claim 5, the predetermined information element is set as Need ON in accordance with one of the 3GPP.

10. A control method for a mobile terminal in accordance with one of the 3GPP (Third Generation Partnership Project), comprising:
receiving an incoming message comprising a predetermined information element from a base station;
storing a value of the predetermined information element as a received element value;
performing a control of storing the received element value in place of a previously stored element value corresponding to a previously received information element; and
transmitting, to the base station, an outgoing message comprising identification information identifying the incoming message received by the receiver.

11. A control method for a radio base station, comprising:
transmitting an outgoing message comprising a predetermined information element to a mobile terminal;
receiving, from the mobile terminal, an incoming message comprising an identification information identifying the outgoing message received by the mobile terminal;
storing the identification information; and
performing a control of the predetermined information element based on the identification information.
